(19) United States
(12) Patent Application Publication
(10) Pub. No.: US 2023/0334171 A1
(43) Pub. Date: Oct. 19, 2023

(54) METHOD AND SYSTEM FOR CRYPTOGRAPHICALLY SECURING AND DEIDENTIFYING HEALTHCARE SERVICE RECORDS AND ASSOCIATED DATA WHILE MAINTAINING PROOF OF UNIQUENESS AND AUTHENTICITY

(71) Applicant: Aspire GP LLC, Lancaster, PA (US)

(72) Inventors: Essam Abadir, Lancaster, PA (US); Victor Owuor, Eden Prairie, MN (US); Scott R. Schell, Lancaster, PA (US)

(21) Appl. No.: 18/303,495

(22) Filed: Apr. 19, 2023

Related U.S. Application Data
(60) Provisional application No. 63/363,190, filed on Apr. 19, 2022.

(51) Int. Cl. G06F 21/62; G06F 21/60

(52) U.S. Cl. CPC G06F 21/6245; G06F 21/602

(57) ABSTRACT

A method and system for securely storing information about digital patient reviews and ratings about healthcare services and associated healthcare providers, and more particularly to a blockchain, a method of cryptographic controls and audits, a system of storage and retrieval of these reviews that allows contemporaneous access to the healthcare services and review information while preventing disclosure of personal health information.

### PRIORITY CLAIM

The application is based on and claims priority to U.S. Provisional Application No.) 63/363,190, filed Apr. 19, 2022, the entirety of each which is incorporated by reference.

### FIELD

The present disclosure relates to a method and system for securely storing information about digital patient reviews and ratings about healthcare services and associated healthcare providers, and more particularly to a cryptographically secured database (such as a blockchain), a method of cryptographic controls and audits, a system of storage and retrieval of these reviews that allows contemporaneous access to the healthcare services and review information while preventing disclosure of personal health information.

### BACKGROUND

For consumer goods and services, digital reviews and ratings directly influence up to 35% of purchasing decisions. Digital reviews and ratings of healthcare services and healthcare providers, including physicians, nurses, pharmacists, and other allied healthcare professionals has steadily increased in healthcare, and these support patients' informed consumer decisions regarding healthcare service quality, cost, and value. While a significant number of Internet sites exist for digital healthcare reviews and ratings, these are burdened by incomplete data, inconsistent methodologies, small numbers of reviews, constraints imposed by regional and medical specialty-specific data, and a general lack of statistical validity of the data. As with consumer goods and services outside healthcare, up to ten percent of healthcare reviews and ratings are fake. Specifically, reviews can be created when healthcare services were never provided or received, multiple reviews created for one single healthcare service, or even when no doctor-patient relationship exists. Fake reviews impair accurate patient choices, obfuscates quality, and increases cost inefficiencies. The market lacks a large-scale, private, and authentic healthcare reviews and ratings system which cryptographically protects health information, validates delivery of healthcare services, and ensure one review is uniquely linked to its underlying healthcare service event.

In some known system, a general interface is made available to the public by registering an account or anonymously to find physicians on the database and enter a review and/or rating for that physician. The information is saved on the site's underlying database and the security and verification configuration is limited to a simple online database that is only accessible to the site provider. In some other known systems, a service provider such as a hospital can send requests for service review and/or rating in connection with its staff. These are also closed system that have limited capability to implement secure anonymity to participants, an audit trail, or flexible integration of many different service provider entities.

Features, functions, processes, and systems contemplated herein provide advances over the known prior art.

### SUMMARY

The present disclosure is directed to a method and system for securely receiving healthcare service records, soliciting, and receiving patient healthcare service reviews, and systems to ensure that healthcare service and patient review data are private and unique, and auditable. The system also allows for retrieval of reviews, and ratings calculated from reviews.

In accordance with a first embodiment of the present disclosure, a method to record healthcare transactions on a public, distributed, network comprises a number of steps. Patient visit information is received, for example from an electronic health record system associated with a hospital or a doctor's office. The visit information comprises data elements, one or more of which may be private. The data elements could include an external visit identifier, a visit date, a practice National Provider Identifier (“NPI”) number, a provider NPI number, a location id, a patient age range, a patient gender, or patient race. Any or all of those data elements could be deemed private or confidential depending on laws and policies in effect. Private data at least refers to information that is descriptive of the patient's name and treatment. An algorithm combines the data elements to create a derived visit identifier. Private data elements contained within the patient visit information cannot be derived from the derived visit identified, which means that the derived visit identifier may not have to be kept private. If the derived visit identifier is not already included in a visit identifier list, then the derived visit identifier is added to that list. The visit identifier is stored within a public distributed network, such as a public blockchain.

The algorithm is a one-way function that does not allow private data elements with the patient visit information to be extracted or inferred from the derived visit identifier. This allows the derived identifier to be stored publicly and used without compromising patient privacy. The algorithm may be a cryptographic hash function of the data elements, such as a secure hash algorithm, that also includes a salt as an added input to further obscure the private data elements.

The method includes sending a patient survey request, for example to the patient corresponding to the patient visit information. The survey request includes the derived visit identifier, so that it can be matched to the patient visit. In addition to the derived visit identifier, the survey response may include a visit identifier, a survey date, a provider score, or an external patient identifier. A patient survey response corresponding to said patient visit information is received from the patient. The patient survey response includes said derived visit identifier, allowing it to be matched to the corresponding survey request and to the patient visit. Upon receiving the patient survey response, the method verifies that derived visit identifier is included in the visit identifier list to ascertain that it is a review for a valid visit. The method also verifies that it is not already included in a survey response list stored within the public distributed network. If it is not in the survey response list but it is in the visit identifier list, then derived visit identifier is added to the list and the response is accepted and it is added to a collection of survey responses. If the derived visit identifier is already on the list then the patient survey response is rejected. In this way, the method ensures that only valid reviews that can be matched against validated patient visit information are accepted. It also avoids duplicate reviews for the same patient visit information.

The patient visit information may be received from a trusted witness validator. The witness validator is challenged and authenticated before the patient visit information is received from them. The method also verifies that the validator is included in a list of authorized validators. The list of authorized validators is stored within the public distributed network.

In accordance with a second embodiment of the present disclosure, a computer readable medium configures a computer to record healthcare transactions on a public, distributed, network according to the first embodiment of the present disclosure.

In accordance with the principles of the invention, one or more embodiments are contemplated. For example, a computer implemented method can be provided to record healthcare transactions on a public, distributed, network. The method can include receiving patient visit information, comprising data elements at least one of which is a private data element, using an algorithm to combine said data elements to create a derived visit identifier, wherein said private data element cannot be obtained from said derived visit identifier, verifying that said derived visit identifier is not included in a visit identifier list stored within said public distributed network and adding said derived visit identifier to said visit identifier list. The algorithm can be a one-way function that can be configured to
create a cryptographic hash function (e.g., a secure hash algorithm) of the data elements. The algorithm can further include a salt as an input to the cryptographic hash function.

The public distributed network can be a blockchain. The data elements may include at least one of external visit identifier, visit date, practice NPI number, provider NPI number, location id, patient age range, patient gender, or patient race. The private data element(s) includes at least one of external visit identifier, visit date, practice NPI number, provider NPI number, location id, patient age range, patient gender, patient race.

The method, for example, includes sending a patient survey request corresponding to said patient visit information, wherein said survey request including said derived visit identifier. The method can further include receiving a patient survey response corresponding to said patient visit information, wherein said patient survey response including said derived visit identifier. In addition, the method can include verifying that said derived visit identifier is included in said visit identifier list, verifying that said derived visit identifier is not included in a survey response list stored within said public distributed network, and adding said patient survey response to said survey response list. A second patient survey response can be received that includes a derived visit identifier that is included in the survey response list and rejecting said second patient survey response.

The survey response can include one of visit identifier, survey date, provider score, or external patient identifier. The visit information is received from a witness validator, wherein the method further comprising authenticating said witness validator prior to receiving said patient visit information, and verifying that said witness validator is included on a list of witness validators stored within a public network.

It is understood that related systems and computer readable medium embodiments are contemplated.

### BRIEF DESCRIPTION OF DRAWINGS

The foregoing and other features and advantages of the present disclosure will become apparent to those skilled in the art to which the present disclosure relates upon reading the following description with reference to the accompanying drawings, in which:

FIG. 1 describes the steps employed in the proof of privacy technology in accordance with one or more embodiments of the present invention.

FIG. 2 describes the steps employed in the proof of uniqueness technology in accordance with one or more embodiments of the present invention.

FIG. 3 describes the steps employed in the proof of authenticity technology in accordance with one or more embodiments of the present invention.

FIG. 4 is a functional block diagram illustrative of network arrangement of system components in accordance with one or more embodiments.

FIG. 5 contains two parts that are illustrative of an email message and a generated report in accordance with one or more embodiments of the present invention.

### DETAILED DESCRIPTION

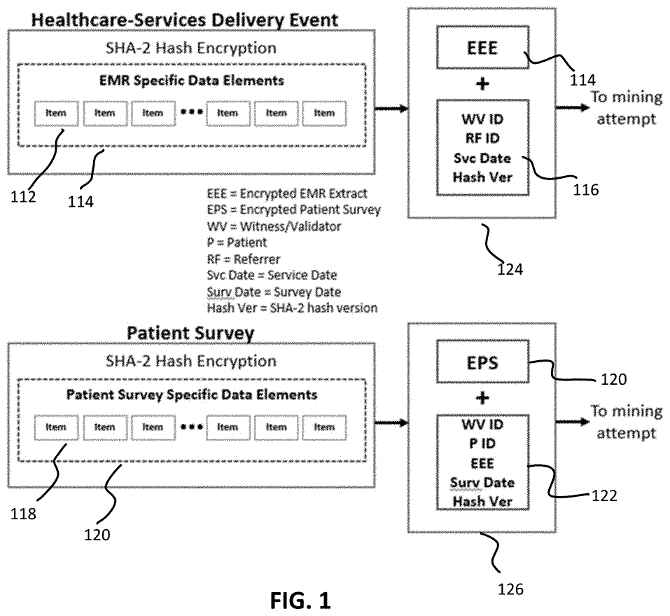

FIG. 1 Illustrates receipt of specific data elements from either a healthcare services delivery event or patient survey, where these data elements are combined and subjected to an encryption hash (EEE or EPS) as described above. The encryption hash produced is then combined with specific information that identify the individuals who submitted, or facilitated, submission of the data elements, the respective date the data were created, and the version of the cryptographic hash employed to encrypt the data elements shown. After creating an irreversibly encrypted hash, the data are submitted for an attempt to write them to the blockchain.

With reference to FIG. 1, data structures are illustrated that are configured to be implemented, used, or stored on a computer system or transmitted in packetized messages. The computer system can receive electronic medical records (“EMR”) and particular data elements 112 of EMRs from a source computer system such as a witness validator (generally referring to computer system of witness validator). Data elements 112 can be or can include data elements generated from a patient record from a visit or treatment, a health-care services delivery event, and the data element(s) can be private data elements. The system is configured to apply SHA-2 hash encryption to the data elements 112 that produces an encrypted EMR extract (“EEE”) 114 (together data 124). The system saves the EEE 114 and further stores the EEE 114 in association with other EEE related data 116. The other data 116 is shown to include a witness validator identification, the treatment service date, and SHA-2 hash version used for the encryption. The data elements can include a referrer identification. Referrers are adjuncts systems to witness validators, that create connectors or integration with certified EMR systems or other systems. Referrers participate in the integration and distribution of EMR by providing or implementing tools or services. Witness validator systems are preferably configured to meet stringent requirements for integrating with certified electronic medical record systems, and protocols for data privacy, integrity, and security. Witness validator systems retrieve Electronic Healthcare Service (“EHS”) records, which include EMRs, from healthcare providers and administer electronic patient surveys (EPS). The process illustrated in FIG. 1 is sometimes referred to as the proof of privacy step.

The bottom half of FIG. 1 shows that the computer system can receive patent survey specific data elements 118 of EMRs from a source computer system such as a witness validator. Data elements 118 can be or can include data elements generated from a patient completing a survey comprising a review and/or rating in connection with a particular visit or treatment. The system is configured to apply SHA-2 hash encryption to the data elements 118 that produces an encrypted patient survey (“EPS”) 120 (which can include portions thereof and/or related data). The system saves the EPS and further stores the EPS in association with other EPS related data 122 (together data 126). The other data 122 is shown to include a witness validator identification, a patient identifier, EEE, the treatment service date, and SHA-2 hash version used for the encryption. The patient identifier is a nondescript descript identifier such as a set of number and does not include patient identifying information.

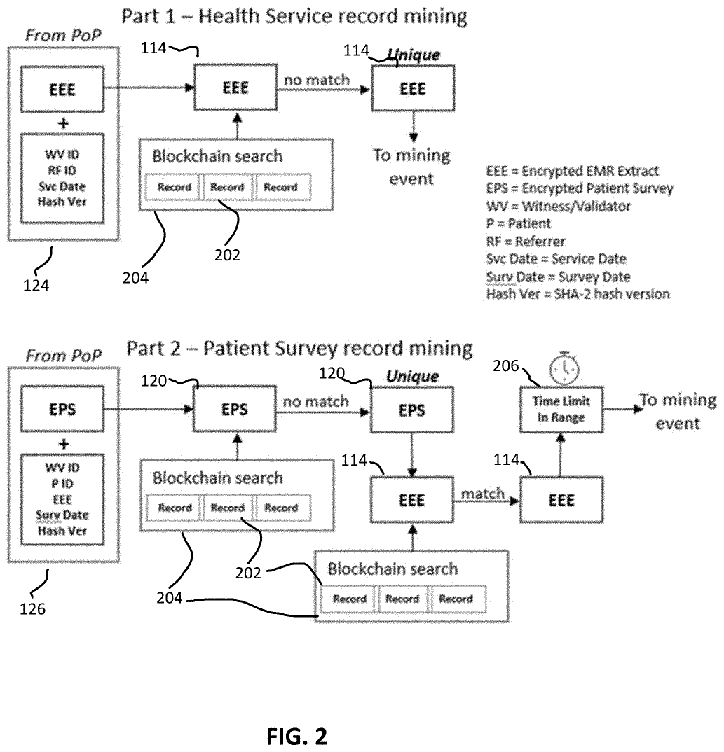

FIG. 2 Illustrates the process for verifying data has not been recorded to the blockchain, and therefore are unique. The information produced, including the encryption hash for healthcare services or patient survey are received from the previous, proof of privacy, step and the EEE or EPS are compared to records previously recorded to the blockchain. In the case of healthcare service records, if no existing EEE has been found recorded to the blockchain, then the EEE and associated information are recorded to the blockchain and tokens are produced. As shown the system is configured to receive or use data 124 to read or retrieve EEE 114. The system is configured to search 204 the records 202 in the blockchain to find whether EEE 114 is already stored on blockchain 202. In response to determining that EEE 114 is not saved on blockchain 202 (and is therefore unique), the system is configured to add EEE 114 to blockchain 202 such as by having a mining operation performed by a node on blockchain.

In the case of EPS, if: a) no existing EPS has been found recorded to the blockchain and; b) a matching EEE associated with the survey is found on the blockchain, and; c) optionally, the current time that this transaction is being undertaken does not exceed a defined number of days when compared to the service date recorded on the blockchain associated with the EEE, then the EPS and associated information are recorded to the blockchain and tokens are produced. For example, as shown in the Part 2 of FIG. 2, in the case of patient survey records, the system is configured to receive or use data 126 to read or retrieve EPS 116. The system is configured to search 204 the records 202 in the blockchain to find whether EPS 116 is already stored on blockchain 202. In response to determining that EPS 116 is not saved on blockchain 202 (and is therefore unique), the system is configured to use EEE 114 associated with that EPS 116 (from data 126) to search 204 (verify) that the associated EEE 114 is correspondingly saved in the records 202 on the blockchain. In the event the system determines that associated EEE 114 is saved as a record in the blockchain, the system indicates the match and moves to the next step. At step 206, the system may be configured to perform a process that uses the treatment service data from data 126 to evaluate whether the service occurred within a defined data limit (e.g., 275 days from the current date) and if the service date meets this criteria, in response, the system is configured to take the action to add the EPS 116 to the records stored on the blockchain using for example a mining operation.

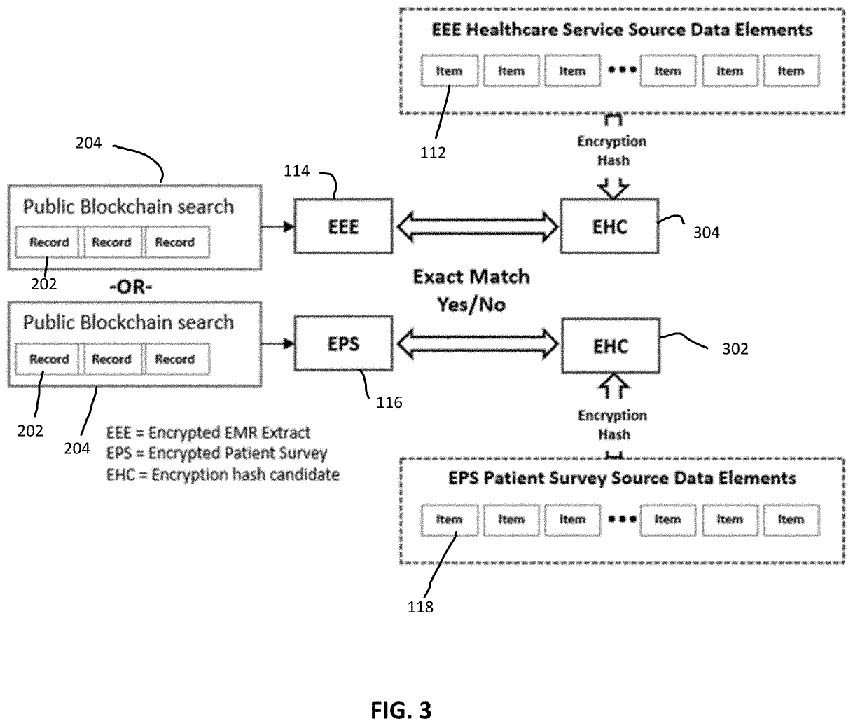

FIG. 3 Illustrates the process for audit and verification of data previously recorded to the blockchain. If desired, an auditor examining the blockchain receives the original source data for the record 112 118 identified by the unique EEE 114 or EPS 116 encryption hash. Using the same encryption hash technique, the auditor (system) subjects the source data to encryption and compares the resulting encryption has to the data under examination, the encrypted hash candidates 302 or 304, on the blockchain. A match verifies the authenticity of the data recorded to the blockchain. This can be provided, as mentioned, by configuring the blockchain to a public blockchain. A public blockchain is configured to permit public access to data recorded on nodes of the blockchain. This can for example allow a computer on the Internet to send a request according to a preset protocol to a blockchain node to receive requested data without requiring the computer to present login credential or requiring that the server be part of the same network domain as the node.

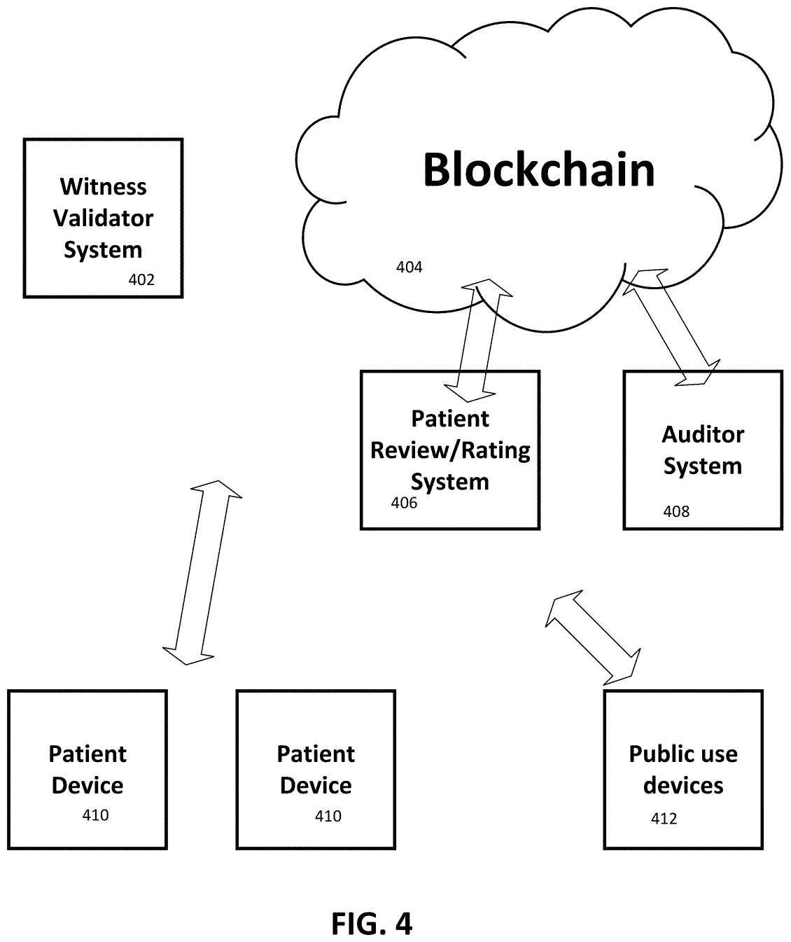

With reference now to FIG. 4, systems can be configured to provide an improved patient treatment survey and rating system in accordance with one or more embodiments. The systems or servers illustrated in FIG. 4 can all be on or implemented in a WAN and preferably the Internet. FIG. 4 shows witness validator system 402, blockchain 404, patient review and rating system 406, auditor system 408, patient devices 410, and public devices 412. Witness validator system 402 is a system that collects and verifies electronic medical records when a patient services. Witness validator system 402 are currently available as part of health records systems and networks. Witness validator system 402 can be representative of multiple different and independent service providers that each obtain and can send EMR records from different service provider entities such that the system can operate openly and provide reviews from many different independent entities. Patient review and rating system 406 receives EMRs and/or electronic patient surveys from witness validator system 402. Other implementations are contemplated such as receiving EMR and survey elsewhere such the review and rating system 406 sending and receiving surveys to patients.

Rating and review system 406 is configured to implement the structures and process illustratively described in FIGS. 1 and 2 and to some extent in FIG. 3. Auditor system 408 is configured to implement the structures and processes of FIG. 3. Variations are contemplated such the system 406 being configured to perform an audit process.

Patient devices can be computers connected to the Internet that receive patient survey requests via email such as from witness validator systems 402 in response to the a system 402 receive an EMR for a patient (which can contain email or cell information). When a patient select to do the survey, a browser window is used, for example, to display questions to answer and rating to the patient to select for that particular treatment. As mentioned, the review can include the EEE. As discussed, blockchain 404 is configured to store the EEEs and EPSs and blockchain 404 can b be configured to be a public blockchain to allow public access to the data recorded on the distributed ledger of the blockchain 404. Review and rating system 406 can be configured to include software process that interface with the blockchain 404 to search the blockchain 404 to collect and compile current information about a physician or treatment provider from the recorded information. System 406 can compile and save the information and periodically update the information by checking for updates on the blockchain 404. Public use devices 412 are illustrated to represent that the system is configured to display review and rating information to the public when requested such as by the system 406 displaying ratings for a physicians via a browser.

Blockchain 404 is configured to store the anonymized, deidentified, and/or cryptographically encoded information in accordance with a blockchain protocol. The blockchain 404 that records transactions and maintains them across computers that are linked in a peer-to-peer network. Blockchain 404 that includes a plurality of node computers and a communications network connecting the plurality of node computers. Each node computer in the plurality includes a processor, memory storing computer instructions executable by the processor, and a network interface operatively coupled to the processor and the communications network which may be a wide area network such as the Internet. The blockchain 404 is implemented with a blockchain consensus software application (blockchain consensus protocol). The blockchain consensus software application is adapted to connect to the plurality of node computers through the communications network. The blockchain consensus software application configures the blockchain system 404 to operate using the data structures and related features. Communication between node computers are by way of digital messages constructed by the node and transmitted to other node computers using packets over a communications network.

The node computers can operate to reach a consensus on adding transactions (such as to add data items) to an overall transaction record maintained by the blockchain system and have an agreement on what the overall transaction record is. Each node in the blockchain 404 may be referred to as a consensus node. The overall transaction record is where all the transactions processed through the blockchain system 404 is stored. The overall transaction record is kept in the form of a blockchain. Node computers in the blockchain system may have its own copy of the transaction record(s) or blockchain. A node computer might have a different copy of the overall blockchain temporarily, but node computers will eventually agree on a same overall blockchain. The blockchain means a distributed ledger in which transactions are maintained across several node computers that are linked and immutable in a peer-to-peer network. Maintain means that each node computer has a local copy of the blockchain or transactions processed through the blockchain system and can update its local copy when new transactions or proposals are received in the blockchain 404.

A block refers to a block on a blockchain or a block to be added onto a blockchain so that it extends from the latest block from a blockchain. A block may include transactions, hash of the previous electronic block, hash of the current electronic block, a timestamp, Merkle root, target, nonce, and other information, or one or more of the aforementioned information.

In general, the reference to system refers to computer systems.

It is understood from the above description that the functionality and features of the systems, devices, or methods of embodiments of the present invention include generating and sending signals to accomplish the actions.

The file or record that is stored on the blockchain can include other data or data fields (values for data values) that are implemented or used by the blockchain ledger protocol of the blockchain on which it is recorded.

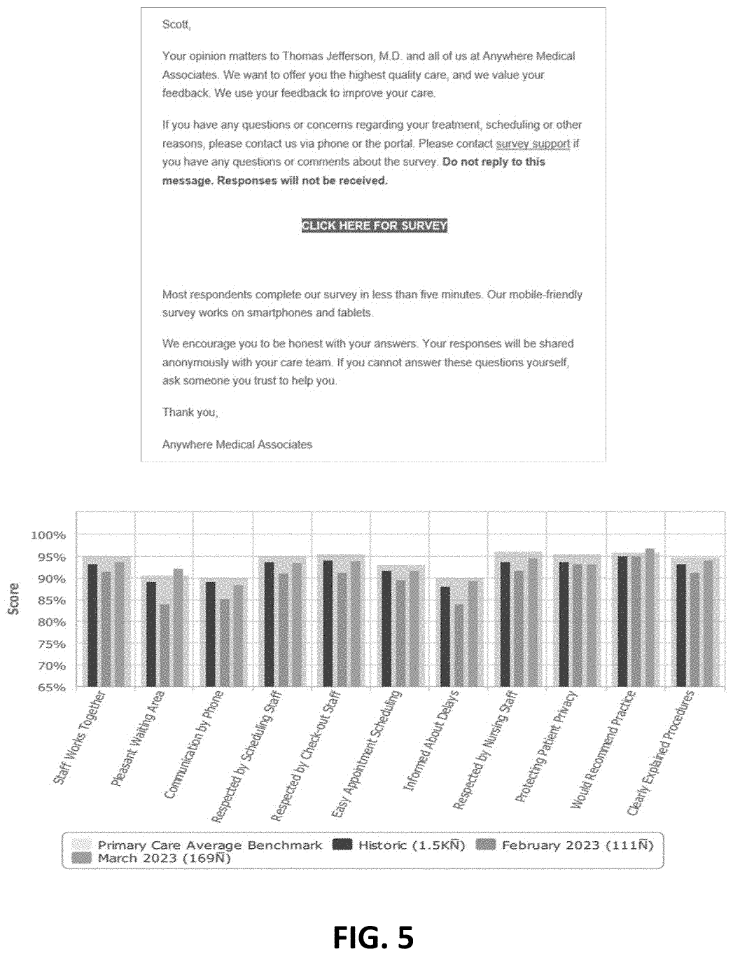

FIG. 5 contains two parts. The top part demonstrates an email message that is generated automatically by the system and transmitted to the patient that is the subject of the EMR by the system such as the review and rating system 406. Another system may send the message and in some embodiments the rating and review system 406 provides the supporting features of collecting, processing, and implementing the processes involved in creating and adding records to the blockchain (and related features). For example, system 406 would be a tool that the validator systems 402 can integrate in combination with survey services that they may be performing. The bottom part illustrates a sample computer generated report produced from the data stored by the review and rating system 406 and blockchain 404. This and other reports can be generated using an interface for treatment provider entity or the public using software configured for providing reports. The generation and interface can be for example be performed by the witness validator system 402, review and rating system 406 and/or other system(s).

Protocols, algorithms, or functionality described in this application are implemented on computers (e.g., node computers) that are connected by a communications network. The communications network can include the Internet, a cellular network, a telephone network, a computer network, a packet switching network, a wide area network (WAN), a global area network, or other network. Embodiments of the present invention are directed to systems, devices, and methods that perform the protocols and algorithms. Embodiments of the present invention are also related to a non-transient computer readable medium configured to carry out any one of the methods disclosed herein. The protocols, algorithms, or features can be a set of computer instructions readable by a processor and stored on the non-transient computer readable medium. Such medium may be permanent or semi-permanent memory such as hard drive, floppy drive, optical disk, flash memory, ROM, EPROM, EEPROM, etc., as would be known to those of ordinary skill in the art. Block or blockchain information may be stored on the non-transient computer readable medium or the memory. Memory, for example, may be cache memory, semi-permanent memory such as RAM, and/or one or more types of memory used for temporarily storing data.

Processor may include an application specific integrated circuit (ASIC), programmable logic array (PLA), digital signal processor (DSP), field programmable gate array (FPGA), or any other integrated circuit. Processor can also include one or more of any other applicable processors, such as a system-on-a-chip that combines one or more of a CPU, an application processor, and memory, or a reduced instruction set computing (RISC) processor.

It is understood that embodiments of the present invention are computer-implemented systems or processes.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not necessarily be interpreted as being restrictive. Accordingly, it should be understood that although steps of various processes or methods or connections or sequence of operations may be shown and described as being in a sequence or temporal order, but they are not necessarily limited to being carried out in any particular sequence or order. Moreover, in some discussions, it would be evident to those of ordinary skill in the art that a subsequent action, process, or feature is in response to an earlier action, process, or feature (even though not explicitly stated).

It is also implicit and understood that the applications or systems illustratively described herein provide computer-implemented functionality that automatically performs a process or process steps unless the description explicitly describes user intervention or manual operation.

It is also implicit and understood that the applications or systems illustratively described herein include a computer includes non-transitory or non-volatile computer readable memory that stores computer readable instructions that when executed by a computer perform processes, steps, or operations that are described herein (implicitly or explicitly).

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

What is claimed is one or more system, method, or computer readable medium that comprises one or more features (e.g., combination of features) described herein, that can include generic claim elements based on species or embodiments described or understood from the present description.

It should be understood that combinations of described features or steps are contemplated even if they are not described directly together or not in the same context.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

The terms “may” or “can” are used herein to communicate that the description is not limited to that described implementation. If the terms are not used, it should be understood that the specification provides examples and information reflective of the one or more embodiments of the invention.

From the above description of the disclosed technology, those skilled in the art will perceive improvements, changes, and modifications. Such improvements, changes, and/or modifications within the skill of the art are intended to be covered by the appended claims.

We claim:

1. A method to record healthcare transactions on a public, distributed, network comprising:
receiving patient visit information, comprising data elements at least one of which is a private data element;
using an algorithm to combine said data elements to create a derived visit identifier, wherein said private data element cannot be obtained from said derived visit identifier;
verifying that said derived visit identifier is not included in a visit identifier list stored within said public distributed network;
adding said derived visit identifier to said visit identifier list.

2. The method of claim 1, wherein said algorithm is a one-way function.

3. The method of claim 2, wherein said algorithm includes creating a cryptographic hash function of said data elements.

4. The method of claim 3, wherein said cryptographic hash function is a secure hash algorithm.

5. The Method of claim 3, wherein said algorithm further includes a salt as an input to the cryptographic hash function.

6. The method of claim 1, wherein said public distributed network is a blockchain.

7. The method of claim 1, wherein said data elements includes at least one of external visit identifier, visit date, practice NPI number, provider NPI number, location id, patient age range, patient gender, patient race.

8. The method of claim 1, wherein said private data element includes at least one of external visit identifier, visit date, practice NPI number, provider NPI number, location id, patient age range, patient gender, patient race.

9. The method of claim 1, further comprising:
sending a patient survey request corresponding to said patient visit information, said survey request including said derived visit identifier.

10. The method of claim 1, further comprising:
receiving a patient survey response corresponding to said patient visit information; said patient survey response including said derived visit identifier.

11. The method of claim 10, further comprising:
verifying that said derived visit identifier is included in said visit identifier list;
verifying that said derived visit identifier is not included in a survey response list stored within said public distributed network;
adding said patient survey response to said survey response list.

12. The method of claim 11, further comprising:
receiving a second patient survey response including a derived visit identifier that is included in the survey response list;
rejecting said second patient survey response.

13. The method of claim 10, wherein said survey response further includes one of visit identifier, survey date, provider score, or external patient identifier.

14. The method of claim 1, wherein said patient visit information is received from a witness validator, the method further comprising:
authenticating said witness validator prior to receiving said patient visit information;
verifying that said witness validator is included on a list of witness validators stored within a public network.

15. A computer readable medium that configures a computer to record healthcare transactions on a public, distributed, network by:
receiving patient visit information, comprising data elements at least one of which is a private data element;
using an algorithm to combine said data elements to create a derived visit identifier, wherein said private data element cannot be obtained from said derived visit identifier;
verifying that said derived visit identifier is not included in a visit identifier list stored within said public distributed network;
adding said derived visit identifier to said visit identifier list.

16. The medium of claim 15, wherein said algorithm is a one-way function.

17. The medium of claim 16, wherein said algorithm includes creating a cryptographic hash function of said data elements.

18. The medium of claim 17, wherein said cryptographic hash function is a secure hash algorithm.

19. The medium of claim 17, wherein said algorithm further includes a salt as an input to the cryptographic hash function.

20. The medium of claim 15, wherein said public distributed network is a blockchain.

21. The medium of claim 15, wherein said data elements includes at least one of external visit identifier, visit date, practice NPI number, provider NPI number, location id, patient age range, patient gender, patient race.

22. The medium of claim 15, wherein said private data element includes at least one of external visit identifier, visit date, practice NPI number, provider NPI number, location id, patient age range, patient gender, patient race.

23. The medium of claim 15, further configuring the computer to:
send a patient survey request corresponding to said patient visit information, said survey request including said derived visit identifier.

24. The medium of claim 15, further configuring the computer to:
receive a patient survey response corresponding to said patient visit information; said patient survey response including said derived visit identifier.

25. The medium of claim 24, further configuring the computer to:
verifying that said derived visit identifier is included in said visit identifier list;
verify that said derived visit identifier is not included in a survey response list stored within said public distributed network;
add said patient survey response to said survey response list.

26. The medium of claim 25, further configuring the computer to:
receive a second patient survey response including a derived visit identifier that is included in the survey response list;
reject said second patient survey response.

27. The medium of claim 24, wherein said survey response further includes one of visit identifier, survey date, provider score, or external patient identifier.

28. The medium of claim 15, wherein said patient visit information is received from a witness validator, the medium further configuring the computer to:
authenticate said witness validator prior to receiving said patient visit information;
verify that said witness validator is included on a list of witness validators stored within a public network.
